(19) United States
(12) Patent Application Publication
(10) Pub. No.: US 2009/0319529 A1
(43) Pub. Date: Dec. 24, 2009

(54) Information Rights Management

(75) Inventors: Wendy S. Bartlett, Clearwater, FL (US); Noah Z. Stahl, Largo, FL (US); Randall S. Brooks, Apollo Beach, FL (US)

Correspondence Address: BAKER BOTTS LLP, 2001 ROSS AVENUE, 6TH FLOOR, DALLAS, TX, 75201-2980, US

(73) Assignee: Raytheon Company, Waltham, MA (US)

(21) Appl. No.: 12/487,353

(22) Filed: Jun. 18, 2009

Related U.S. Application Data
(60) Provisional application No. 61/132,762, filed on Jun. 20, 2008.

(51) Int. Cl. H04L 9/32; G06F 17/30

(52) U.S. Cl. 707/9; 726/5; 707/E17.005; 707/E17.032

(57) ABSTRACT

In certain embodiments, a method for providing information rights management (IRM) includes receiving, from a user having an associated security access profile, a request to access an object. The object has a corresponding IRM wrapper stored with the object both when the object is stored in a document management system (DMS) database and external to the DMS database, the IRM wrapper including an IRM profile and one or more IRM permission sets. The object also has encrypted data. The method further includes determining whether the user is authorized to access the object based on a comparison of the security access profile of the user and the IRM profile of the IRM wrapper corresponding to the object and communicating to the user, in response to a determination that the user is authorized to access the object, a decryption key associated with object.

### RELATED APPLICATIONS

This application claims the benefit under 35 U.S.C. section 119(e) of the priority of U.S. Provisional Application No. 61/132,762, filed Jun. 20, 2008, entitled “CHAIN Information Rights Management.”

### TECHNICAL FIELD

This invention relates generally to object management and more particularly to information rights management.

### BACKGROUND

It is often beneficial for an entity such as an enterprise to manage electronic objects (e.g., documents) using a document management system. In general, a document management system is a system for one or more of tracking, storing, editing, and securing electronic objects. As an example, a document management system may be a complex computer-implemented system for managing electronic objects from a number of geographically distributed locations. In certain systems, the document management system may provide functionality for securing electronic objects managed using the document management system.

### SUMMARY

According to the present invention, disadvantages and problems associated with previous techniques for providing information rights management may be reduced or eliminated.

In certain embodiments, a method for providing information rights management (IRM) includes receiving, from a user having an associated security access profile, a request to access an object. The object has a corresponding IRM wrapper stored with the object both when the object is stored in a document management system (DMS) database and external to the DMS database, the IRM wrapper including an IRM profile and one or more IRM permission sets. The object also has encrypted data. The method further includes determining whether the user is authorized to access the object based on a comparison of the security access profile of the user and the IRM profile of the IRM wrapper corresponding to the object and communicating to the user, in response to a determination that the user is authorized to access the object, a decryption key associated with object.

Particular embodiments of the present invention may provide one or more technical advantages. In many applications, it may be beneficial for an entity to have a document management system that allows personnel within the entity to share objects (e.g., documents) stored in a DMS database to facilitate collaboration within the entity. Additionally, it may also be beneficial for personnel within the entity to store objects external to the DMS database. The ability to share objects and collaborate, however, may need to be balanced with a need to maintain a degree of control over which personnel within the entity may access or otherwise interact with possibly sensitive data. Conventional document management systems, such as that provided by the Documentum 6, SP1 content server coupled with the Webtop client interface, may provide an entity with the ability for personnel to share objects and collaborate in various ways, but these conventional systems generally lack the ability to maintain stringent access control according to distinct security levels within the entity.

In certain embodiments, the generation of a security label corresponding to an object (e.g., a document) stored in a DMS database of an entity may allow the entity to manage access to the object according to distinct security levels such that only users having particular security credentials may request access to the object from DMS database (e.g., by selecting a link associated with the object). Additionally, the use of an IRM wrapper corresponding to the object may further allow the entity to manage access to the object such that only those users having particular security credentials may receive a decryption key associated with the object. Because the IRM wrapper may be stored with the object both when the object is stored in the DMS database and when the object is stored external to the DMS database, access to the object, based on the IRM wrapper, may be managed both when the object is stored in the DMS database and when the object is stored external to the DMS database (e.g., when the object has been exported from the DMS database).

Thus, in certain embodiments, for an object having both a corresponding security label and a corresponding IRM wrapper, the entity may be able to control access to the object both when the object is stored within the DMS database (by determining both whether a user is authorized to view a link associated with the object based on the corresponding security label and whether the user is authorized to access the object based on the corresponding IRM wrapper) and when the object is stored external to the DMS database (by determining whether the user is authorized to access the object based on the IRM wrapper). Therefore, an entity may maintain the ability to control access to objects according to distinct security levels regardless of whether the objects are stored in a DMS database or external to the DMS database, thereby increasing security while maintaining and/or increasing the ability for personnel within the entity to share objects and collaborate in various ways.

Certain embodiments of the present invention may include some, all, or none of the above advantages. One or more other technical advantages may be readily apparent to those skilled in the art from the figures, descriptions, and claims included herein.

### BRIEF DESCRIPTION OF THE DRAWINGS

To provide a more complete understanding of the present invention and the features and advantages thereof, reference is made to the following description taken in conjunction with the accompanying drawings, in which:

FIG. 1 illustrates an example system for providing information rights management, according to certain embodiments of the present invention;

FIG. 2 illustrates example functions performed by users and administrators via a document management application in an example system for providing information rights management, according to certain embodiments of the present invention;

FIG. 3 illustrates example functions performed by users and administrators via an IRM application in an example system for providing information rights management, according to certain embodiments of the present invention;

FIG. 4 illustrates an example IRM-protected object stored in a DMS database in an example system for providing information rights management, according to certain embodiments of the present invention;

FIG. 5 illustrates an example IRM-protected object stored external to a DMS database in an example system for providing information rights management, according to certain embodiments of the present invention;

FIG. 6 illustrates an example method for determining whether a user is authorized to view a link associated with an object stored in a DMS database in an example system for providing information rights management, according to certain embodiments of the present invention;

FIG. 7 illustrates an example method for determining whether a user is authorized to access an object stored either in a DMS database or external to a DMS database in an example system for providing information rights management, according to certain embodiments of the present invention; and

FIG. 8 illustrates an example method for determining whether a user is authorized to view links associated with objects stored in a DMS database in response to the receipt of login credentials from the user, according to certain embodiments of the present invention.

### DESCRIPTION OF EXAMPLE EMBODIMENTS

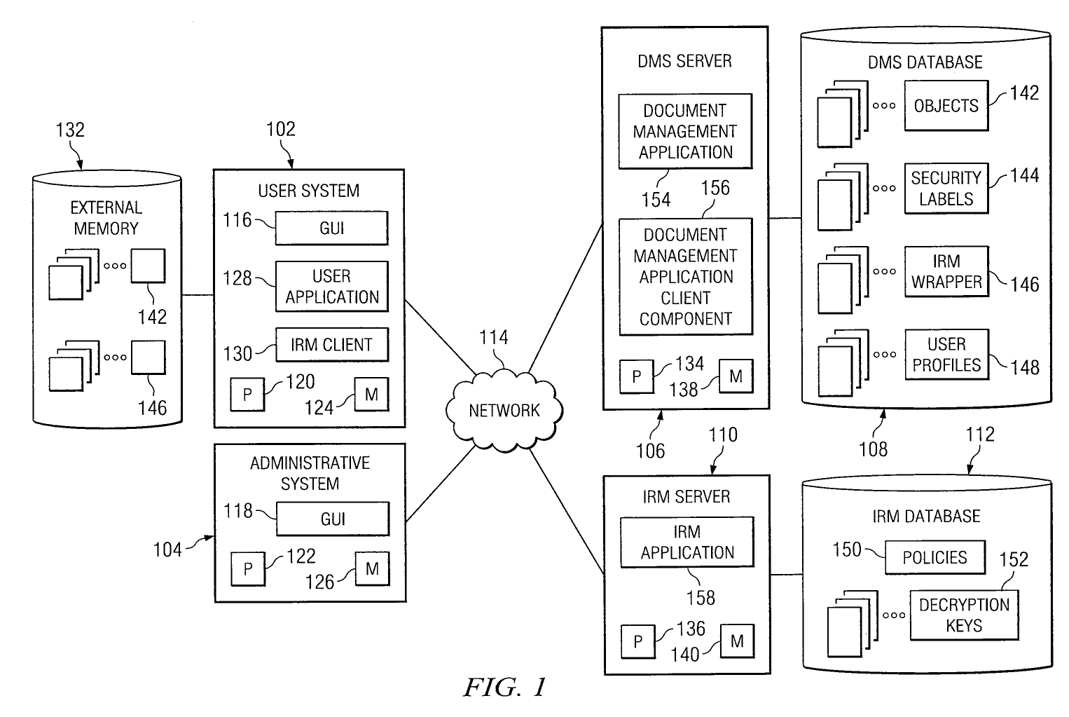

FIG. 1 illustrates an example system 100 for providing information rights management (IRM), according to certain embodiments of the present invention. System 100 may include one or more user systems 102, one or more administrative systems 104, one or more document management system (DMS) servers 106, and one or more DMS databases 108. System 100 may further include one or more IRM servers 110, one or more IRM databases 112, and a network 114. Although this particular implementation of system 100 is illustrated and primarily described, the present invention contemplates any suitable implementation of system 100 according to particular needs.

In general, system 100 is operable manage both access to objects stored in DMS database 108 and access to objects stored external to DMS database 108 (e.g., objects that have been exported from DMS database 108 and stored in an external storage device, such as external memory 132 of user system 102). An object may include a spreadsheet, a text document, an e-mail, a web page, program source code, an image file, or any other suitable type of electronic data object.

System 100 may manage access to an object regardless of whether the object is stored in DMS database 108 or external to DMS database 108 by generating both a security label corresponding to the object and IRM wrapper corresponding to the object. The security label may govern whether a particular user may request access to the object when the object is stored in DMS database 108 by providing a basis for determining whether the particular user may view a link associated with the object. More particularly, the security label corresponding to the object may be compared with a security access profile of the particular user to determine whether the particular user is authorized to view the link associated with the object, the particular user requesting access to the document by selecting the link associated with the object.

The IRM wrapper may govern whether a particular user may actually access the object (i.e., receive a decryption key associated with the object) regardless of whether the object is stored in the DMS database 108 or external to the DMS database 108. More particularly, an IRM profile of the IRM wrapper corresponding to the object may be compared with the security access profile of the particular user to determine whether the user is authorized to access the object. In response to determining that the user is authorized to access the particular object, a decryption key associated with the object may be communicated to the particular user. The decryption key may be used by a user to decrypt encrypted data of the object.

As a result, certain embodiments of the present invention may allow an entity to maintain the ability to control access to objects according to distinct security levels regardless of whether the objects are stored in a DMS database or external to the DMS database, thereby increasing security while maintaining and/or increasing the ability for personnel within the entity to share objects and collaborate in various ways.

The one or more user systems 102 and one or more administrative systems 104 of system 100 may each include one or more computer systems at one or more locations. Each computer system may include any appropriate input devices (such as a keypad, touch screen, mouse, or other device that can accept information), output devices, mass storage media, or other suitable components for receiving, processing, storing, and communicating data. Both the input devices and output devices may include fixed or removable storage media such as a magnetic computer disk, CD-ROM, or other suitable media operable to both receive input from and provide output to a user of user system 102 or a user of administrative system 104. Each computer system may include a personal computer, workstation, network computer, kiosk, wireless data port, personal data assistant (PDA), one or more processors within these or other devices, or any other suitable processing device. Additionally, the one or more user systems 102 and one or more administrative systems 104 may each include any suitable combination of software, firmware, and hardware.

As an example, system 100 may include multiple distributed user systems 102 and/or multiple distributed administrative systems 104. User systems 102 and administrative systems 104 may be physically distributed, being in different locations geographically remote from each other and from the other components of system 100, or logically distributed, being at approximately the same location as other user systems 102 and administrative systems 104 and the other components of system 100. For simplicity, the one or more user systems 102 and the one or more administrative systems 104 of system 100 are each referred to throughout this description primarily in the singular.

“User system 102” and “user of user system 102” may be used interchangeably. Likewise, “administrative system 104” and “user of administrative system 104” may be used interchangeably. A user of user system 102 and/or a user of administrative system 104 may include, for example, a human user or a computer program or other suitable software module for automatically interacting with administrative system 104.

In certain embodiments, user system 102 and administrative system 104 may include a graphical user interfaces (GUIs) 116 and 118, respectively, that allow user system 102 and administrative system 104 to interact with other components of system 100. In certain embodiments, GUIs 116 and 118 may be delivered using an online portal or hypertext mark-up language (HTML) pages for display and data capture.

User system 102 and administrative system 104 may also each include one or more processing modules (i.e., processing module 120 and processing module 122 respectively) and one or more memory modules (i.e., memory module 124 and memory module 126, respectively). A processing module as described herein may include one or more microprocessors, controllers, or any other suitable computing devices or resources and may work, either alone or with other components of system 100, to provide a portion or all of the functionality of system 100 described herein. A memory module as described herein may take the form of volatile or non-volatile memory including, without limitation, magnetic media, optical media, random access memory (RAM), read-only memory (ROM), removable media, or any other suitable memory component.

Additionally, user system 102 may include a user application 128, an IRM client 130, and an external memory 132. User application 128 of user system 102 may include, for example, MICROSOFT Word, MICROSOFT PowerPoint, MICROSOFT Excel, or any other suitable application for accessing, viewing, and/or editing electronic objects (e.g., objects 142 stored in DMS database 108 and/or external memory 132, as described in further detail below).

IRM client 130 of user system 102 may facilitate communication between user system 102 and IRM server 110 such that a user of user system 102 may access an IRM-protected object (e.g., an object 142 having a corresponding IRM wrapper 146) either from DMS database 108 or a storage location external to DMS database 108 (e.g., external memory 132) by obtaining a decryption key associated with the IRM-protected object, as described in further detail below.

External memory 132 of user system 102 may include a memory module, such as a hard drive associated with user system 102, a thumb drive, a CD-ROM, or any other storage device external to DMS database 108 and accessible to user system 102.

Although user system 102 and administrative system 104 are illustrated and primarily described as being separate, it is understood that the computer systems and the functionality associated with user system 102 and administrative system 104 may be combined or separated in any suitable manner.

The one or more DMS servers 106 and one or more IRM servers 110 of system 100 may each include one or more electronic computing devices operable to receive, transmit, process, and store data associated with system 100. For example, DMS servers 106 and IRM servers 110 may each include one or more general-purpose PCs, Macintoshes, workstations, Unix-based computers, server computers, one or more server pools, or any other suitable devices. For simplicity, the one or DMS server 106 and one or more IRM servers 110 of system 100 are each referred to throughout this description primarily in the singular.

DMS server 106 and IRM server 110 may each include any suitable combination of software, firmware, and hardware. Additionally, DMS server 106 and IRM server 110 may each include a processing module (i.e., processing module 134 and processing module 138, respectively) and a memory module 118 (i.e., memory module 138 and memory module 140, respectively).

Although DMS server 106 and IRM server 110 are illustrated and primarily described as being separate, the present invention contemplates the functionality associated with DMS server 106 and IRM server 110 (as described below) being combined on a single server or divided among any suitable number of servers, according to particular needs. Moreover, although DMS server 106 and IRM server 110 are referred to as a “servers,” the present invention contemplates DMS server 106 and IRM server 110 comprising any suitable type of processing device or devices.

Network 114 of system 100 may communicatively couple user system 102 and administrative system 104 to one another as well as to DMS server 106 and IRM server 110. Network 114 facilitates wireless or wireline communication. Network 114 may communicate, for example, IP packets, Frame Relay frames, Asynchronous Transfer Mode (ATM) cells, voice, video, data, and other suitable information between network addresses. Network 114 may include one or more local area networks (LANs), radio access networks (RANs), metropolitan area networks (MANs), wide area networks (WANs), all or a portion of the global computer network known as the Internet, and/or any other communication system or systems at one or more locations.

The one or more DMS databases 108 and one or more IRM databases 112 of system 100, although primarily described as being “databases,” may each include any other suitable memory module and may take the form of volatile or non-volatile memory, including, without limitation, magnetic media, optical media, RAM, ROM, removable media, or any other suitable local or remote memory component. In certain embodiments, the one or more DMS databases 108 and/or the one or more IRM database 112 may include one or more SQL servers. Furthermore, in certain embodiments, DMS databases 108 and/or IRM databases 110 may combined with DMS server 106 and/or IRM server 110, according to particular needs. For simplicity, the one or more DMS databases 108 and one or more IRM databases 112 of system 100 are each referred to throughout this description primarily in the singular.

DMS database 108 may store a plurality of objects 142. An object 142 may include a spreadsheet, a text document, an e-mail, a web page, program source code, an image file, or any other suitable type of electronic object. In certain embodiments, one or more objects 142 stored in DMS database 108 are encrypted.

DMS database 108 may additionally store a plurality of security labels 144 and a plurality of IRM wrappers 146. Each security label 144 stored in DMS database 108 may correspond to an object 142 stored in DMS database 108 or external to DMS database 108 (e.g., an object 142 that has been exported from DMS database 108, as described in further detail below). Additionally, each IRM wrapper 146 stored in DMS database 108 may correspond to an object 142 stored in DMS database 108.

DMS database 108 may additionally store plurality security access profiles 148, each security access profile 148 associated with a user of system 100 (e.g., a user of user system 102). Each security access profile may include information regarding the associated user, such as login information (e.g., username and password) and group membership information (as described in further detail below).

IRM database 112 may store IRM policies 150. IRM policies 150 may include plurality of permission sets defined by a user of administrative system 104 or other suitable person (e.g., a software developer) that, when incorporated into an IRM wrapper 146 corresponding to an object 142 as one or more IRM permission sets, may define a number of actions that a user accessing the object 142 may or may not perform (as described in further detail below).

IRM database 112 may additionally store a plurality of decryption keys 152. Decryption keys 152 may be associated with both objects 142 stored in DMS database 108 and objects 142 stored external to DMS database 108 (e.g., objects 142 stored in external memory 132 of user system 102). More particularly, a decryption key 152 may correspond to encrypted data of an object 142 such that a user possessing the decryption key 152 associated with the object 142 may decrypt the encrypted data of the object 142 whether the object 142 is accessed from DMS database 108 or from a memory unit external to DMS database 108 (as described in further detail below).

DMS server 106 of system 100 may include a document management application 154. DMS server 106 may also include a document management application client component (“client component”) 156 that provides an interface for user system 102 and administrative system 104 to interact with document management application 154. Document management application 154 and client component 156 may each include any suitable combination of hardware, firmware, and software. Although certain functionality described below is described as being associated with either client component 156 or document management application 154, it is understood that the functionality may be provided by any suitable combination of document management application 154, client component 156, and any other suitable component of system 100.

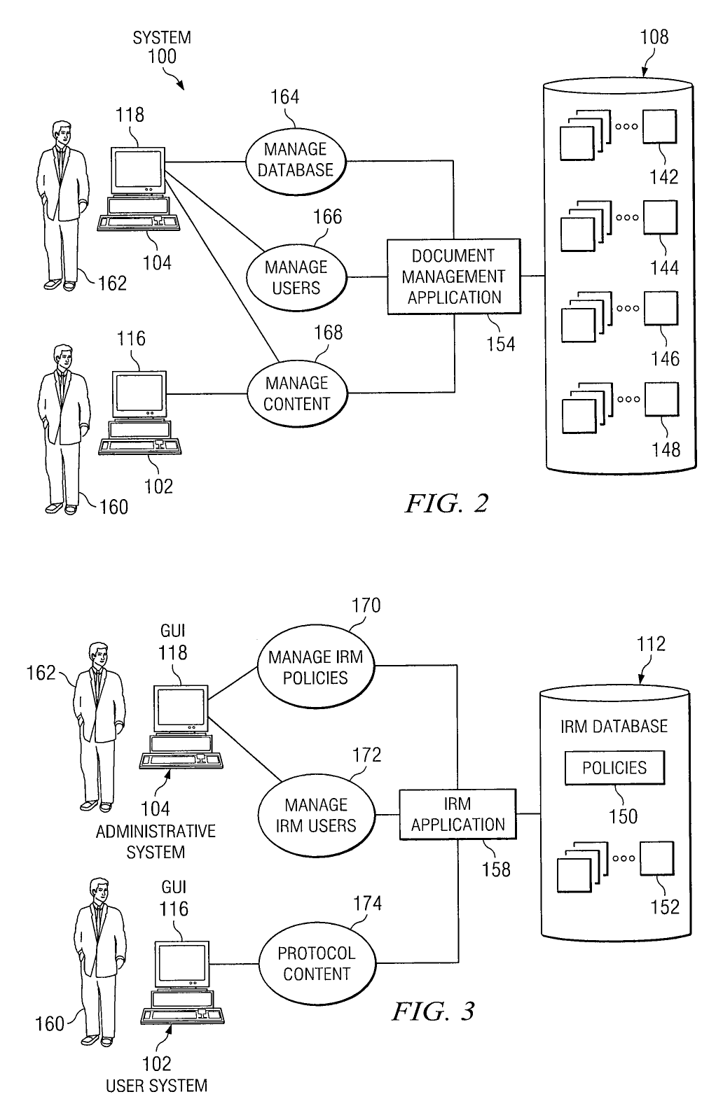

Document management application 154 of DMS server 106 may be operable to provide an administrator (e.g., a user of administrative system 104) with the ability to manage users of system 100 and DMS database 108 (as illustrated in FIG. 2). Managing the users of system 100 and DMS database 108 may include creating groups, creating users, deleting groups, deleting users, assigning an existing user to a new group, modifying a user, and/or any other suitable functions, according to particular needs.

For example, document management application 154 may allow an administrator to manage users of system 100 by creating one or more groups. As a particular example, in a national defense context an administrator may create a number of clearance groups (e.g., TOP-SECRET clearance group, SECRET clearance group, and CONFIDENTIAL clearance group). The clearance groups may be arranged in a vertical hierarchy such that, for example, a member of the TOP-SECRET clearance group would also, by default, be a member of all lesser groups (i.e., SECRET and CONFIDENTIAL clearance groups in this example). As another particular example, an administrator may create one or more secondary security groups (e.g., each clearance group described in the example above may have a DALLAS OFFICE group, a Washington D.C. office group, and a NEW YORK OFFICE group). Furthermore, each secondary security group may be associated with a particular clearance group such that the secondary security groups may be arranged horizontally within each clearance group. This horizontal arrangement of secondary security groups within each clearance group may result in a lack of a hierarchy, meaning that membership in one secondary security group would not necessarily indicate, by default, membership in another secondary security group.

As another example, document management application 154 may allow an administrator to manage users of system 100 by creating one or more users. For example, an administrator may create a user by generating login information (e.g., a username and password) for the user. Furthermore, the administrator may be able to assign the created user to one or more groups. The login information and the one or more groups assigned to a particular user may define, at least in part, a security access profile 148 associated with the user, the security access profiles 148 associated with the one or more users of system 100 being stored in DMS database 108 and/or IRM database 112.

Document management application 154 of DMS server 106 may allow a user of user system 102 to manage the content of objects 142 stored in DMS database 108 (as illustrated in FIG. 2). Managing the content of an objects 142 stored in DMS database 108 may include storing objects 142 in DMS database 108, facilitating the creation of a security label 144 corresponding to an object 142 stored in DMS database 108, or any other suitable function according to particular needs.

For example, document management application 154 may allow a user of user system 102 to manage the content of objects 142 stored in DMS database 108 by allowing the user to store an object 142 in DMS database 108. Storing an object 142 in DMS database 108, as described herein, may include creating a new document, importing an existing document, or checking in an edited version of an object 142 already stored in DMS database 108

As another example, document management application 154 may allow a user of user system 102 to manage the content of objects 142 stored in DMS database 108 by facilitating the creation by the user of a security label 144 corresponding to an object 142 stored in DMS database 108. The security label 144 corresponding to an object 142 may be generated independent of input received from the user (e.g., the security label 144 may be created by document management application 154) or in response to input received from the user (i.e., the user may create the security label 144 by specifying the one or more components of the security label, as described below). In certain embodiments, document management application 154 may facilitate the creation of a security label 144 corresponding to each object 142 stored in DMS database 108. In other words, prior to allowing a user to store an object 142 in DMS database 108, document management application 154 may facilitate the creation of a security label 144 corresponding to the object 142 such that each object 142 of DMS database 108 has a corresponding security label 144.

A security label 144 corresponding to an object 142 may include one or more components. One or more of the components of a security label 144 may correspond to the one or more defined groups of users, the groups of users having been defined by an administrator, as described above. For example, a security label 144 may include a clearance component corresponding to a clearance group (e.g., TOP-SECRET, SECRET, or CONFIDENTIAL) and a secondary security component corresponding to a secondary security group (e.g., DALLAS OFFICE, WASHINGTON OFFICE, and NEW YORK OFFICE). Additionally, one or more other components of a security label 144 corresponding to an object 142 may not correspond to the one or more defined groups of a user seeking to generate and/or modify/amend the security label 144. For example, a security label 144 may include a handling component (e.g., proprietary) that indicates some additional information about the data contained in the document.

In certain embodiments, the available clearance and/or secondary security components of a security label 144 corresponding to a particular object 142 may be limited based upon the group memberships of the user seeking to generate and/or modify/amend the security label 144 corresponding to the particular object 142. In other words, a user may only be able to designate security label components corresponding to a group to which the user belong. For example, a user belonging to the SECRET clearance group and the DALLAS OFFICE secondary security group seeking to generate a security label 144 corresponding to an object 142 may specify that the clearance component of the security label be either SECRET or CONFIDENTIAL (as the users belongs to both groups in this example) and that the secondary security component of the security label be DALLAS OFFICE.

Although a clearance and a secondary security component may be specified for a security label 144, the present invention contemplates that a clearance component for a security label 144 may not be specified (e.g., the clearance component may be designated as “unclassified”), a secondary security component for a security label 144 may not be specified (e.g., the secondary security component may be designated as “unspecified”), or both.

Furthermore, if the clearance component of a security label 144 is designated as “unclassified,” there may be no restriction as to which users may view a link associated with the object 142 based on the group memberships of the users (i.e., no secondary security component selection is necessary, as secondary security components are sub-components of the clearance component selection). In certain embodiments, if the clearance component of the security label 144 is not specified (e.g., the clearance component is designated as “unclassified”), the security label 144 may additionally include a handling component. The handling component may not serve to restrict the users who may view a link corresponding to the object 142 may but may instead indicate information associated with the object 142 (e.g., that the data contained in the object 142 is proprietary). Examples of these scenarios are described below in greater detail.

In certain embodiments, client component 156 of DMS server 106 is operable to facilitate interaction between user system 102 and document management application 154 in the creation of the security label 144 corresponding to an object 142 sought to be stored in DMS database 108. Client component 156 may facilitate interaction between user system 102 and document management application 154 by determining the intersection between the available security label components and those components the user is authorized to select based on user's security access profile 148 stored in DMS database 108. Once the appropriate intersection is determined, client component 156 may populate a menu with the available component options, the menu being displayed to the user of system 102 via GUI 112. In the above-described example in which the user belongs to the SECRET clearance group, the clearance component menu would include SECRET, CONFIDENTIAL, and unclassified selections for the clearance component of the security label 144. The user of user system 102 may select the desired clearance component of the security label (e.g., SECRET) using the clearance component menu.

In response to user selection of a clearance component for the security label 144, client component 156 may populate a menu including secondary security components associated with the selected clearance component. In the above-described example in which the user of user system 102 is a member of the DALLAS OFFICE secondary security group only, the secondary security component menu would include a DALLAS OFFICE selection for the secondary security component of the security label 144. Additionally, as described above, a secondary security component may not be specified such that further access will not be restricted according to secondary security group membership. Thus, the secondary security component menu would also include an unspecified selection for the secondary security component of the security label 144. The user of system 102 may then select the desired one or more secondary security components of the security label (e.g., DALLAS OFFICE).

If the clearance component of the security label is unspecified (e.g., designated as “unclassified,” as described above), client component 156 may not populate a secondary security component menu, but instead, may populate a handling component menu with the possible handling components. Because a handling component may be selected when document access will not be restricted according to group membership, the handling component menu may include all possible handling component selections (i.e., the handling component selections may not be limited based on the group memberships of the user seeking to generate and/or amend/modify the security label 144). As a particular example, if a user generating a security label 144 corresponding to an object 142 sought to be stored in DMS database 108 specifies that the clearance component be unclassified, the user may specify a handling component for the security label 144 (e.g., proprietary, indicating that although access to the document will not be restricted, the document contains proprietary information).

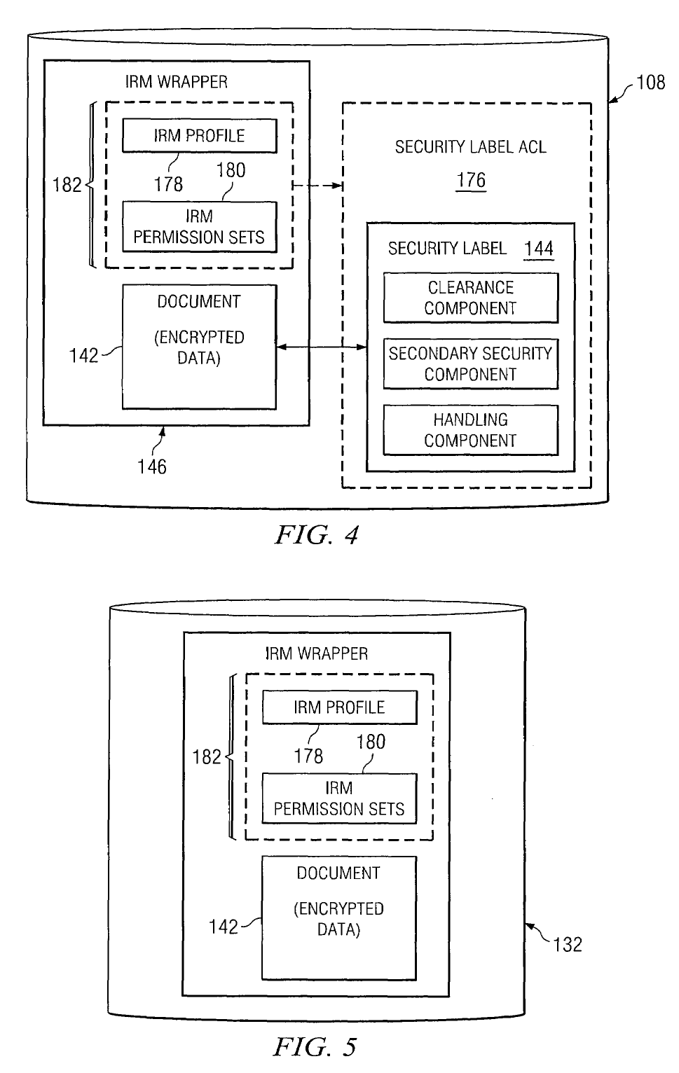

Document management application 154 may store the security label 144 corresponding to the object 142, in addition to the object 142, in DMS database 108. In certain embodiments, document management application 154 may additionally or alternatively store all or part of the security label 144 (i.e., the specified components) in a generated security label access control list (ACL) associated with the security label 144 corresponding the object 142 (e.g., as illustrated in FIG. 4). Furthermore, in certain embodiments, the data contained in the security label 144 (i.e., the specified components) may be stored as a portion of the data content of the object 142 to which the security label 144 corresponds such that a user viewing the data content of the object 142 may view the data contained in the security label.

Having generated and stored objects 142 and their corresponding security labels 144 (and possibly a security label ACL) in DMS database 108, document management application 154 may determine if a user of system 102 is authorized to request access to the objects 142. For example, document management application 154 may determine if a user is authorized to request access to the objects 142 stored in DMS database 108 by determining whether the user is authorized to view links associated with objects 142. In certain embodiments, a link associated with an object 142 may include a virtual document generated by document management application 154 and displayed to a user of system 102 via GUI 116.

Document management application 154 may determine if a user of user system 102 is authorized to view links associated with objects 142 stored in DMS database 108 by comparing security labels 144 corresponding to the objects 142 with the security access profile 148 of the user. Although document management application 154 is described as comparing security labels 144 corresponding to an object 142 with the security access profile 148 of a user to determine if the user is authorized to view links associated with the objects 142, the present invention contemplates document management application 154 additionally or alternatively comparing all or a part of security label ACLs associated with the security labels 144 corresponding to the objects 142 with the security access profile 148 of the user to determine if the user is authorized to view links associated with objects 142 stored in DMS database 108.

In certain embodiments, document management application 154 may determine whether a user is authorized to view links associated with objects 142 stored in DMS database 108 in response to the receipt of user login credentials (e.g., username and password) from the user. For example, a user of user system 102 may login to DMS server 106/DMS database 108 by providing login credentials, and document management application 154 may validate the provided login credentials by determining if the provided login credentials correspond to the login credentials of an authorized user stored in DMS database 108 (e.g., in a security access profile 148 stored in DMS database 108). In response to validating the login credentials provided by the user, document management application 154 may access the security access profile 148 of the user and compare the accessed security access profile 148 of the user with security labels 144 corresponding to documents 142 stored in DMS database 108 to determine those objects 142 for which the user is authorized to view a link.

As an example, a particular object 142 stored in DMS database 108 may have a corresponding security label 144 comprising a clearance component (SECRET) and a secondary security component (DALLAS OFFICE). In response to validating the login credentials provided by a user, document management application 154 may access the security access profile 148 associated with the validated user and compare at least a portion of the accessed security access profile 148 with the security label 144 corresponding to the particular object 142.

If the validated user has an associated security access profile 148 indicating that the user belongs to the TOP-SECRET clearance group and the DALLAS OFFICE secondary security group, document management application 154 may determine that the validated user is authorized to view a link associated with the particular object 142, as the validated user would belong to both groups specified by the components of the security label for the object 142.

If instead the validated user has an associated security access profile 148 indicating that the validated user belongs to the SECRET clearance group and the WASHINGTON OFFICE secondary security group, document management application 154 may determine that the validated user is not authorized to view a link associated with the object 142, as the secondary security group of the validated user (WASHINGTON OFFICE) is different than the secondary security component of the security label (DALLAS OFFICE).

As another example, a particular object 142 stored in DMS database 108 may have a corresponding security label 144 comprising a clearance component (unclassified) and a handling component (proprietary). A validated user may be allowed to view a link associated with the particular object 142 regardless of the security access profile 148 of the validated user, as the security label 144 corresponding to the particular object 142 indicates that the clearance component is unclassified (as the unclassified category indicates that access to the object 142 is not restricted according to group membership and the handling component is not restrictive in that it does not correspond to group membership but merely provides information relevant to the object 142).

Based on the determination of those objects 142 that the validated user is authorized to view based on the comparison of the security labels 144 corresponding to the objects 142 and the security access profile 148 of the user, document management application 154 may generate a virtual document to be displayed to the user via GUI 116, the generated virtual document including child virtual documents (i.e., links) each corresponding to an object 142 that the validated user is authorized to view. As a particular example, the virtual document comprising the one or more child documents may appear as a tree-like directory structure.

In certain embodiments, document management application 154 may determine whether a user is authorized to view links associated with objects 142 stored in DMS database 108 in response to the receipt of query request from the user. For example, in response to receiving a query request for objects 142 from a user of system 102, document management application 154 may determine those objects 142 that meet query parameters of the query request. Document management application 154 may compare the security labels 144 corresponding to each of the objects 142 meeting the query parameters to the security access profile 148 of the user (as described above) to determine those objects 142 for which the user is authorized to view a link. Based on the determination of those objects 142 both meeting the query parameters and for which the user is authorized to view a link, document management application 154 may generate a virtual document to be displayed to the user via GUI 116. The generated virtual document may include child virtual documents (i.e., links) each corresponding to an object 142 meeting the query parameters that the user is authorized to view.

Once a user is authorized to view links associated with one or more objects 142, a user of user system 102 may request access to a particular object 142 by selecting the link associated with the object 142.

For a requested object 142 that is not IRM protected (i.e., an object 142 stored in DMS database 108 that does not have a corresponding IRM wrapper 146), document management application 154 may communicate the requested object 142 to the user such that the user may view the content of the object 142, export the object 142 by storing the document external to DMS database 108 (e.g., on external memory 132), edit the object 142, or perform any other suitable operation with respect to the object 142.

For a requested object that is IRM protected (i.e., an object 142 stored in DMS database 108 that does have a corresponding IRM wrapper 146), document management application 154 may communicate the IRM-protected object 142 to the user in response to the request (i.e., the selecting of the link associated with the object). However, prior to viewing the content of the IRM-protected object 142, exporting the IRM-protected object 142 by storing the document external to DMS database 108 (e.g., on external memory 132), or editing the IRM-protected object 142, IRM client 130 of user system 102 may communicate with IRM server 110 such that IRM application 158 of IRM server 110 may determine whether the user is authorized to access the IRM-protected object 142, as described in further detail below.

Having accessed a requested object 142 (either an non-IRM-protected object 142 or an IRM-protected object 142), a user may seek to store an edited version of the object 142 in DMS database 108 (e.g., to check-in the document with its revisions). The edited version of the object 142 may replace the corresponding accessed object 142, be stored in addition to the corresponding accessed object 142, or be stored in any other suitable manner.

Additionally, document management application 154 may allow the user to update the security label for the edited version of the object 142 to account for edits the user may have made to the object. As a particular example, a user of user system 102 having an associated security access profile 148 indicating that the user belongs to the TOP-SECRET clearance group and the DALLAS OFFICE secondary security group may access a non-IRM-protected object 142 (i.e., an object not having a corresponding IRM wrapper 146) having a corresponding security label 144 including a SECRET clearance component and a DALLAS OFFICE secondary security component.

The user may edit the accessed object 142 by adding content to the object 142 and seek to store the edited version of the object 142 in DMS database 108. As a result of the added content, the user may update the security label associated with the edited version of the object 142, the updating of the security label taking into account the group memberships of the editing user, as described above regarding the creation of the security label. For example, the user may update the security label 144 corresponding to the accessed and edited object 142 such that the updated security label 144 comprises a TOP-SECRET clearance component and a DALLAS OFFICE secondary component.

IRM server 110 of system 100 may include an IRM application 158. IRM application 158 may be operable to provide an administrator (e.g., a user of administrative system 104) with the ability to manage IRM policies and IRM users (e.g., as illustrated in FIG. 3). Although certain functionality with regard to managing IRM policies and managing IRM users is described below as being performed by IRM application 158, document management application 154 of DMS server 106, and/or client component 156 of DMS server 106, the present invention contemplates the functionality being performed by any suitable combination of IRM application 158, document management application 154 of DMS server 106, and client component 156 of DMS server 106.

IRM application 158 of IRM server 110 may allow an administrator to manage IRM policies and IRM users by allowing the administrator to define a permission set of IRM policy 150. An administrator may define a permission set by specifying one or more permissions (i.e., actions) that a user of user system 102 who has received an object 142 and the decryption key 146 associated with the object 142 (as described in further detail below) may (or may not) perform with respect to the object 142. For example, a permission set of an IRM policy 150 may define whether a user may print an accessed object 142, copy an accessed object 142, export an accessed object 142 (i.e., work with the object 142 offline and/or store the object 142 in a memory external to DMS database 108), view IRM activity for an accessed object 142, or any other suitable action, according to particular needs.

IRM application 158 of IRM server 110 may allow an administrator to manage IRM policies and IRM users by allowing the administrator to define authentication criteria. Authentication criteria may include the criteria by which IRM server 150 determines whether a decryption key associated with an object 142 should be communicated to a user of user system 102 such that the user may decrypt the encrypted data content of an object 142. Defining authentication criteria may include defining the portions of an IRM wrapper 146 (corresponding to an object 142) that may be compared with the user access profile 148 of a user requesting access to the object 142 to determine whether a decryption key will be sent to the requesting user. This is described in further detail below.

IRM application 158 of IRM server 110 may allow a user of user system 102 to protect the content of one or more objects 142 stored in DMS database 108 as well as one or more objects 142 stored external to DMS database 108 (as illustrated in FIG. 3). Although certain functionality with regard to protecting the content of one or more objects 142 is described below is described as being performed by IRM application 158, document management application 154 of DMS server 106, and/or client component 156 of DMS server 106, the present invention contemplates the functionality being performed by any suitable combination of IRM application 158, document management application 154 of DMS server 106, and client component 156 of DMS server 106.

IRM application 158 may allow a user of user system 102 to protect the content of one or more objects 142 by facilitating the creation of an IRM wrapper 146 corresponding to an object 142. An IRM wrapper 146 corresponding to an object 142 may include an IRM profile and one or more IRM permission sets (e.g., as illustrated in FIGS. 4-5). In certain embodiments, all or part of the IRM wrapper 146 corresponding to an object 142 may additionally or alternatively be stored as part of a generated IRM wrapper ACL associated with the IRM wrapper 146 (e.g., as illustrated in FIGS. 4-5).

The IRM profile of an IRM wrapper 146 corresponding to an object 142 may include one or more IRM profile components. In certain embodiments, an IRM profile of an IRM wrapper 146 may include IRM profile components corresponding to one or more of the components of the security label 144 corresponding to the object 142 to which the IRM wrapper 146 corresponds. More particularly, the IRM profile of the IRM wrapper 146 may include an IRM profile component corresponding to the clearance component of the security label 144 corresponding to the object 142 and an IRM profile component corresponding to the secondary security component of the security label 144 corresponding to the object 142. In certain embodiments, an IRM profile of an IRM wrapper 146 may additionally or alternatively include IRM profile components corresponding to a list of authorized users authorized to access the object 142 to which the IRM wrapper 146 corresponds. Although IRM profiles of IRM wrappers 146 are primarily described as including particular IRM profile components (e.g., components corresponding to one or more of the components of the security label 144 and/or a list of authorized user), the present invention contemplates an IRM wrapper 146 having a IRM profile including any suitable IRM profile components, according to particular needs.

The IRM profile of an IRM wrapper 146 may further include, in embodiments in which system 100 includes a plurality of IRM servers 110, a specification of a particular IRM server 110 among the plurality of IRM servers 110. The particular IRM server 110 among the plurality of IRM servers 110 may be responsible for managing the decryption key 152 associated with the object 142 to which the IRM wrapper 146 corresponds by determining whether a user requesting to access the object 142 is authorized to receive the decryption key associated with object 142, as described in further detail below.

The IRM permission sets of an IRM wrapper 146 may include one or more permission sets. As described above, a permission set may define a number of actions that that a user accessing the object 142 to which the IRM wrapper 146 corresponds (either from DMS database 108 or a memory unit external to DMS database 108) may (or may not) perform. In certain embodiments, an IRM wrapper 146 may include differing permission sets for different users and/or sets of users. In other words, one user (or group of users) may be authorized to perform different actions with respect to an accessed object 142 to which the IRM wrapper 146 corresponds than another user (or group of users). Although the IRM permission sets of an IRM wrapper are depicted and primarily described as being stored as part of IRM wrapper 146, the present invention contemplates that the IRM permission sets may be accessed from IRM policies 150 of IRM database 112 or stored in/accessed from any other suitable location in system 100.

In certain embodiments, IRM application 158 (either alone or in combination with document management application 154 and/or client component 156 of DMS server 106) may generate the IRM wrapper 146 corresponding to an object 142 in response to input received from the user. IRM application 158 of IRM server 110 may communicate with document management application 154 of DMS server 106 and/or client component 156 of DMS server 106 (e.g., via one or more server extensions) to facilitate the creation of an IRM wrapper 146.

For example, a user of user system 102 may initiate the creation of an IRM wrapper 146, which may correspond to an object 142 stored in DMS database 108. The object 142 may have a corresponding security label 144 generated using document management application 154, as described above. The user may initiate the creation of the IRM wrapper 146 by selecting an appropriate menu provided to the user by document management application 154 and/or client component 156 of DMS server 106 via GUI 112.

In embodiments in which system 100 includes a plurality of IRM servers 110, the user may specify a particular IRM server 110 responsible for determining whether a user requesting access to an object 142 is authorized to receive a decryption key associated with the object 142. The particular IRM server 110 may be stored in the IRM profile of the IRM wrapper 146 corresponding to the object 142.

Additionally, the user may define one or more IRM profile components of the IRM profile of the IRM wrapper 146. For example, a user may select one or more users who are authorized to access the object 142. As a particular example, the menu may include a listing of all users in system 100, and the user may select those users who may access the object 142 to which the IRM wrapper 146 corresponds. Information for the selected users (e.g., login information associated with the selected users) may then be stored in the IRM wrapper 146 as IRM profile components of the IRM profile.

Additionally or alternatively, a user may select one or more groups of users that are authorized to access the object 142. As a particular example, the menu may include a listing of all groups of users in system 100, and the user may select those groups of users that may access the object 142 to which the IRM wrapper 146 corresponds. Information for the selected groups of users may then be stored in the IRM wrapper 146 as IRM profile components of the IRM profile.

The user may define one or more IRM permission sets of the IRM wrapper 146 by selecting one or more permission sets of IRM policy 150 stored in IRM database 112 (e.g., predefined permission sets defined by an administrator, as described above), for example. Furthermore, IRM wrapper 146 may include multiple permission sets such that differing permission sets may be applied according to the group membership of an accessing user. As particular example, a user may select a first permission set to be applied if a user accessing the object 142 belongs to the SECRET clearance group and a second permission set to be applied if the user accessing the document belongs to the TOP-SECRET clearance group. Additionally, the one or more permission sets selected by the user from IRM policies 150 may be modified by adding additional permissions or deleting existing permissions.

In certain embodiments, IRM application 158 of IRM server 110 (either alone or in combination with document management application 154 and/or client component 156 of DMS server 106) may generate the IRM wrapper 146 corresponding to an object 142 independent of input from a user of user system 102. IRM application 158 of IRM server 110 may communicate with document management application 154 of DMS server 106 and/or client component 156 of DMS server 106 (e.g., via one or more server extensions) to facilitate the creation of an IRM wrapper 146.

For example, document management application 154 may automatically generate (i.e., without user input) an IRM wrapper 146 corresponding to an object 142. The IRM profile of the IRM wrapper 146 may include one or more IRM profile components corresponding to the one or more of the components of the security label 144 corresponding to the object 142 (e.g., clearance component and secondary security component), the IRM profile components being accessed from the security label 144 (or security label ACL) such that the IRM profile components may be generated independent of input from a user of user system 102.

The IRM wrapper 146 may also include one or more IRM permission sets. Document management application 154 of DMS server 106 may communicate with IRM application 158 of IRM server 110 to access an IRM policy 150 stored in IRM database 112. IRM policy 150 may include one or more default IRM permission sets to be included in the IRM wrapper 146 in the absence of user input. Furthermore, multiple default IRM permission sets may be included in an IRM wrapper 146 such that differing permission sets may be applied according to the group membership of an accessing user. As a particular example, IRM policy 150 may specify that a first default permission set be included in an IRM wrapper 150 such that accessing users belonging to the SECRET clearance group may perform a first set of action with respect to the object 142, and that a second default IRM profile be included in the IRM wrapper such that accessing users belonging to the TOP-SECRET clearance group may perform a second set of action with respect to the object 142.

Document management application 154 may send an object 142 to which a generated IRM wrapper 146 corresponds to IRM application 158 of IRM server 110. IRM application 158 may receive the object 142 and encrypt all or part of received object 142. Additionally, IRM application 158 may generate a decryption key 152 associated with the object and store the encryption key in IRM database 112. IRM application may communicate the encrypted object 142 back to document management application 154, which may store the encrypted document 142 in DMS database 108, along with the IRM wrapper 146 corresponding to the object 142.

Furthermore, the object 142 and the corresponding IRM wrapper 146 may be associated with one another within DMS database 108 such that the IRM wrapper 146 is stored with the corresponding object 142 regardless of whether is later stored in a location external to DMS database 108. For example, if a user authorized to access the IRM-protected object 142 (as described below) exports the object 142 and stores the object 142 in external memory 150 of user system 102, the IRM wrapper 146 corresponding to the object may be exported along with the object 142 and stored in external memory 150 of user system 102 (as illustrated in FIG. 5).

IRM application 158 may allow a user of user system 102 to protect the content of one or more objects 142 stored in DMS database 142 by determining if a user of user system 102 is authorized to access a requested IRM-protected object 142 stored in DMS database 108. IRM application 158 may determine if a user is authorized to access a requested IRM-protected object 142 stored in DMS database 108 by comparing the IRM profile of the IRM wrapper 146 corresponding to the IRM-protected object 142 with the security access profile 148 of the user. Although IRM application 158 is described as comparing the IRM profile of the IRM wrapper 146 corresponding to an object with the security access profile 148 of the user to determine if the user is authorized to access the object 142, IRM application 158 additionally or alternatively may compare all or a part of an IRM wrapper ACL associated with IRM wrapper 146 corresponding to the object 142 with the security access profile 148 of the user to determine if the user is authorized to access the object 142.

As described above, a user who has been authorized to view a link associated with the IRM-protected object 142 (e.g., based on a comparison of the security label 144 corresponding to the IRM-protected object 142 and the security access profile 148 of the user) may request access to the object 142 by selecting the link. In response to the selection of the link associated with IRM-protected object 142, client component 156 of DMS server 106 may invoke IRM client 130 of user system 102, IRM client 130 operable to communicate with IRM application 158 of IRM server 110 such that IRM application 158 may determine whether the user is authorized to access the IRM-protected object 142.

More particularly, IRM application 158 may determine, based on a comparison of the IRM profile of the IRM wrapper 146 corresponding to the IRM-protected object 142 with the security access profile 148 of the user, if the decryption key 152 associated with the IRM-protected object 142 should be communicated to the user requesting access to the object 142. Because the security access profile 148 may be stored in DMS database 108, IRM application 158 may communicate with document management application 154 of DMS server 106 to access the security access profile 148.

As a particular example, a user may request access to an IRM-protected object 142 stored in DMS database 108. The IRM-protected object 142 may have a corresponding IRM wrapper 146 that includes an IRM profile having one or more IRM profile components corresponding to a list of users (e.g., usernames and/or passwords of users) who are authorized to access the IRM-protected object 142. Client component 156 of DMS server 106 may recognize that the requested object 142 is IRM protected (i.e., that a decryption key associated with the object 142 is needed before user application 128 may open the object 142).

In response to the recognition that the requested object 142 is IRM protected, client component 156 may invoke IRM client 130. IRM client 130 may communicate with IRM application 158 of IRM server 110 such that IRM application 158 may determine, based on a comparison of the IRM profile of the IRM wrapper 146 corresponding to the requested object 142 with the security access profile 148 of the requesting user, whether to communicate a decryption key 152 associated with the object 142 to the requesting user such that the requesting user may access the requested object (e.g., by opening the requested object in user application 128).

IRM application 158 may communicate with document management application 154 of DMS server 106 in order to access the security access profile 148 of the requesting user from DMS database 108. IRM application 158 may compare the accessed security access profile 148 of the requesting user with the IRM profile components of the IRM profile of the IRM wrapper 146 corresponding to the requested object 142 to determine whether the accessed security access profile 148 contains information (e.g., a username and/or password) corresponding to the IRM profile components (e.g., a username and/or password of a user authorized to access the object 142) of the IRM wrapper 146 corresponding to the requested object 142.

If the security access profile 148 of the requesting user contains information (e.g., a username and/or password) corresponding to the IRM profile components (e.g., the username and/or password of a user authorized to access the object 142), IRM application 158 may determine that the requesting user is authorized to access the requested object 142.

As another particular example, a user of user system 102 may request access to an IRM-protected object 142 stored in DMS database 108. The IRM-protected object 142 may have a corresponding IRM wrapper 146 that includes an IRM profile having one or more IRM profile components. These IRM profile components may correspond to the one or more components of the security label 144 for the object 142 (e.g., an IRM profile component corresponding to a clearance component (SECRET) and an IRM profile component corresponding to a secondary security component (DALLAS OFFICE)). Client component 156 of DMS server 106 may recognize that the requested object 142 is IRM protected (i.e., that a decryption key associated with the object 142 is needed before user application 128 may open the object 142).

In response to the recognition that the requested object 142 is IRM protected, client component 156 may invoke IRM client 130. IRM client 130 may communicate with IRM application 158 of IRM server 110 such that IRM application 158 may determine, based on a comparison of the IRM profile of the IRM wrapper 146 corresponding to the requested object 142, whether to communicate a decryption key 152 associated with the object 142 to the requesting user such that the requesting user may access the requested object (e.g., by opening the requested object in user application 128).

IRM application 158 may communicate with document management application 154 of DMS server 106 in order to access the security access profile 148 associated with the requesting user in DMS database 108. IRM application 158 may compare the accessed security access profile 148 of the requesting user with the IRM profile components of the IRM profile of the IRM wrapper 146 corresponding to the requested object 142. This comparison may be used to determine whether the accessed security access profile 148 of the requesting user contains information (e.g., group memberships) corresponding to the one or more IRM profile components (e.g., components corresponding to the clearance component and/or secondary security component of the security label 144 for the requested object 142) of the IRM wrapper 146 corresponding to the requested object 142.

Based on the comparison of the IRM profile components of the IRM wrapper 146 (e.g., an IRM profile component corresponding to a clearance component (SECRET) and an IRM profile component corresponding to a secondary security component (DALLAS OFFICE)) with the security access profile 148 of the requesting user, IRM application 158 may determine that any user belonging to both the SECRET clearance group (or TOP-SECRET clearance group due to hierarchy of groups) and the DALLAS OFFICE secondary security group may be authorized to access the corresponding object 142. As a particular example, if the requesting user has a security access profile 148 indicating that the user belongs to the TOP-SECRET clearance group and the DALLAS OFFICE secondary security group, IRM application 158 may determine that the user is authorized to access the object 142.

In response to determining that a requesting user is authorized to access a IRM-protected object 142, IRM application 158 may access a decryption key 152 associated with the IRM-protected object from IRM database 112. IRM application 158 may communicate the accessed decryption key 152 to the requesting user such that the requesting user may access the IRM-protected object 142 by opening the object 142 in user application 128 and decrypting the object 142 using the associated decryption key 152.

Additionally, the actions the user may perform with respect to the IRM-protected object 142 may be defined by the permission set of the IRM wrapper 146 corresponding to the object 142 (or the appropriate permission set in embodiments in which the IRM wrapper 146 includes differing permission sets for differing users or groups of users, as described above). Furthermore, IRM client 130 may apply the permission set or appropriate permission set corresponding to the object 142 by disabling those functions that a user is not authorized to perform in user application 128.

As a particular example, a user belonging to the SECRET clearance group may be authorized to access an IRM-protected object 142 such that the object can be opened in user application 128 using an associated decryption key 152, but the permission set of the IRM wrapper 146 of the object 142 corresponding to users belonging to the SECRET clearance group may specify that such users may not print the accessed object 142, edit the accessed object 142, or export the accessed object 142 (store external to DMS database 108) the object 142. IRM client 130 may enforce the appropriate permission set by disabling the print, edit, and export functionality of user application 128.

As an additional particular example, a user belonging to the TOP-SECRET clearance group may be authorized to access the IRM-protected object 142 such that the object can be opened in user application 128 using an associated decryption key 152, and the permission set of the IRM wrapper 146 of the object 142 corresponding to users belonging to the TOP-SECRET clearance group may specify that such users may perform any action with respect to the object 142 (e.g., the user may print the accessed object 142, copy the accessed object 142, export the accessed object 142, view IRM activity for the accessed object 142, or any other suitable action) Additionally, IRM application 158 may allow a user of user system 102 to protect the content of one or more objects 142 stored external to DMS database 142 by determining if a user of user system 102 is authorized to access a requested IRM-protected object 142 stored external to DMS database 108 (e.g., in external memory 132 of user system 102).

As described above, a user may generate an IRM wrapper 146 corresponding to an object 142 stored in DMS database 108. Additionally, IRM application 158 may determine whether a user requesting access to the object 142 stored in DMS database 108 is authorized to access the object 142. Assuming that the requesting user is authorized to access the object 142 from DMS database 108 and that the requesting user is authorized to export the object 142 (based on the appropriate permission set of the IRM wrapper 146 corresponding to the object 142), the requesting user may store the object 142 external to DMS database 108 (e.g., in external memory 132 of user system 102. Because the IRM wrapper corresponding to the object 142 is stored with the object regardless of the location of the object (i.e., in DMS database 108 or external to DMS database 108), IRM application 158 may be further determine if a user subsequently seeking to access the object 142 from a location external to DMS database 108 is authorized to access the object 142.

For example, a user of user system 102 may request access to an IRM-protected object 142 stored in external memory 132 of user system 102. User application 128 may recognize that the requested object 142 is IRM protected and may invoke IRM client 130. IRM client 130 may then communicate with IRM application 158 such that IRM application 158 may determine whether the requesting user is authorized to access the IRM protected document. IRM application 158 may determine if the user is authorized to access the requested object 142 in the same manner as described above with regard to objects 142 stored in DMS database 108.

In response to determining that the requesting user is authorized to access the IRM protected document, IRM application 158 may access a decryption key 152 associated with the IRM-protected object 142 and communicate the accessed decryption key 152 to the user such that the user may open the requested object 142 in user application 128 using the associated decryption key 150, as described above. Additionally, IRM client 130 may enforce the appropriate permissions as defined by the appropriate permission set of the IRM wrapper 146 corresponding to the accessed object 142, as described above.

In certain embodiments, the above-described functionality of client component 156 and document management application 154 may be achieved by supplementing and/or modifying the functionality associated with existing document management applications and their associated client applications. A particular example of such an existing document management application and its associated client application are is Documentum 6, SP1 and the client application Webtop. In certain embodiments, document management application Documentum 6, SP1 and client application Webtop may be modified and/or supplemented with additional functionality in order to achieve a portion or all of the functionality described above.

Although a particular implementation of system 100 is illustrated and primarily described, the present invention contemplates any suitable implementation of system 100 according to particular needs. Although a particular number of components of system 100 have been illustrated and primarily described above, the present invention contemplates system 100 including any suitable number of such components. Furthermore, the various components of system 100 described above may be local or remote from one another. Additionally, the components of system 100 may be implemented in any suitable combination of hardware, firmware, and software.

In operation of an example embodiment of system 100, document management application 154 of DMS server 106 may receive a request from a user of user system 102 to view a link associated with an object 142 stored in DMS database 108. The object 142 may have a corresponding security label 144 stored in DMS database 108. In response to the receipt of the request, document management application 154 may retrieve the security access profile 148 of the user to determine whether the user is authorized to view a link associated with the object 142 by comparing the accessed security access profile 148 of the user with the security label 144 corresponding to the object 142.

If document management application 154 determines, based on the comparison of the security access profile 148 of the user and the security label 144 corresponding to the object 142, that the user is authorized to view a link associated with the object 142, document management application 154 may display the link associated with the object 142 to the user.

Document management application 154, having displayed the link associated with the object 142 stored in DMS database 108 to the user, may receive a request from the user to access the object 142 (i.e., the user may select the link associated with the object 142). In response to the receipt of the request, document management application 154 may determine whether the requested object 142 is IRM protected. In other words, document management application 154 may determine if the requested object 142 stored in DMS database 108 has a corresponding IRM wrapper 146 stored in IRM database 108.

If document management application 154 determines that the requested object 142 is not IRM protected (i.e., the requested object 142 does not have a corresponding IRM profile 146), the user may be allowed to access the requested object 142. If document management application 154 determines that the requested object 142 is IRM protected (i.e., the requested object 142 has a corresponding IRM profile 146), client component 156 of DMS server 106 may invoke IRM client 130 of user system 102. IRM client 130 may communicate with IRM application 158 of IRM server 130 such that IRM application 158 may determine whether the requesting user is authorized to access the requested object 142.

IRM application 158 may determine whether the requesting user is authorized to access the requested object 142 based on a comparison of the IRM profile of the IRM wrapper 146 corresponding to the requested object 142 with the security access profile 148 of the requesting user. More particularly, IRM application 158 may compare the IRM profile components of the IRM profile corresponding to the requested object with the security access profile of the user. Because the security access profile 148 may be stored in DMS database 108, IRM application 158 may communicate with document management application 154 of DMS server 106 in order to access the security access profile 148.

If IRM application 158 determines that the requesting user is authorized to access the requested object 142, IRM application 158 may retrieve a decryption key 152 associated with the requested object 142 from IRM database 112. IRM application 158 may communicate the decryption key associated with the requested object 142 to the requesting user such that the requesting user may open the requested object 142 using user application 128 by decrypting the encrypted data of the requested object 142.

Additionally, IRM client 130 may apply the permission set of the IRM wrapper 146 corresponding to the requested object 142 (or the appropriate permission set in embodiments in which the IRM wrapper 146 includes differing permission sets for differing user or groups of users) by disabling those functions that the requesting user is not authorized to perform in user application 128. The requesting user may then export the requested object 142 (e.g., store the object in external memory 132 of user system 102), assuming that the requesting is authorized to do so based on the applied permission set of the IRM wrapper 146 corresponding to the object.

A user (either the exporting user or another user) may then request to access the exported object 142 from external memory 132 by opening the exported object 142 in user application 128 of user system 102. In response to the request, user application 128 may determine if the requested object is IRM protected. In other words, user application 128 may determine if the requested exported object 142 stored in external memory 132 has a corresponding IRM wrapper 146 stored in IRM database 108. If user application 128 determines that the requested exported object 142 is IRM protected (i.e., the requested object has a corresponding IRM profile 146), user application 128 may invoke IRM client 130 of user system 102. IRM client 130 may communicate with IRM application 158 of IRM server 130 such that IRM application 158 may determine whether the requesting user is authorized to access the requested exported object 142, as described above.

Particular embodiments of the present invention may provide one or more technical advantages. In many applications, it may be beneficial for an entity to have a document management system that allows personnel within the entity to share objects (e.g., documents) stored in a DMS database to facilitate collaboration within the entity. Additionally, it may also be beneficial for personnel within the entity to store objects external to the DMS database. The ability to share objects and collaborate, however, may need to be balanced with a need to maintain a degree of control over which personnel within the entity may access or otherwise interact with possibly sensitive data. Conventional document management systems, such as that provided by the Documentum 6, SP1 content server coupled with the Webtop client interface, may provide an entity with the ability for personnel to share objects and collaborate in various ways, but these conventional systems generally lack the ability to maintain stringent access control according to distinct security levels within the entity.

In certain embodiments, the generation of a security label 144 corresponding to an object 142 (e.g., a document) stored in a DMS database 108 of an entity may allow the entity to manage access to the object 142 according to distinct security levels such that only users having particular security credentials may request access to the object 142 from DMS database 108 (e.g., by selecting a link associated with the object). Additionally, the use of an IRM wrapper 146 corresponding to the object 142 may further allow the entity to manage access to the object 142 such that only those users having particular security credentials may receive a decryption key 152 associated with the object 142. Because the IRM wrapper 146 may be stored with the object 142 both when the object 142 is stored in the DMS database 108 and when the object is stored external to the DMS database 108, access to the object 142, based on the IRM wrapper 146, may be managed both when the object 142 is stored in the DMS database 108 and when the object 142 is stored external to the DMS database 108 (e.g., when the object 142 has been exported from the DMS database 108).

Thus, in certain embodiments, for an object 142 having both a corresponding security label 144 and a corresponding IRM wrapper 146, the entity may be able to control access to the object 142 both when the object 142 is stored within the DMS database 108 (by determining both whether a user is authorized to view a link associated with the object 142 based on the corresponding security label 144 and whether the user is authorized to access the object 142 based on the corresponding IRM wrapper 146) and when the object is stored external to the DMS database 108 (by determining whether the user is authorized to access the object 142 based on the IRM wrapper 146). Therefore, an entity may maintain the ability to control access to objects 142 according to distinct security levels regardless of whether the objects 142 are stored in a DMS database 108 or external to the DMS database 108, thereby increasing security while maintaining and/or increasing the ability for personnel within the entity to share objects and collaborate in various ways.

FIG. 2 illustrates example functions performed by users 160 and administrators 162 via document management application 154 in an example system 100 for providing information rights management, according to certain embodiments of the present invention. System 100 includes a user 160 associated with a user system 102 and an administrator 162 associated with an administrative system 104. In the illustrated embodiment, document management application 154 is operable to provide functionality associated with managing DMS database 108 (as indicated at reference numeral 164), managing users of system 100 (as indicated at reference numeral 166), and managing the content of the objects 142 in DMS database 108 (as indicated at reference numeral 168).

In certain embodiments, an administrator 162 of administrative system 104 may manage DMS database 108 (as indicated at reference numeral 164), manage users of system 100 (as indicated at reference numeral 166), and manage the content of objects 142 in DMS database 108 (as indicated at reference numeral 168). Managing DMS database 108 may include managing the properties of DMS database 108. Managing users 160 of system 100 may include creating new users, creating new groups, placing a user in a group, deleting users, or any other suitable function according to particular needs. Managing the content of objects 142 may include the functionality described below with regard to user 160.

In certain embodiments, a user 160 of user system 102 may manage the content of the objects 142 stored in DMS database 108 (as indicated at reference numeral 168). A user may manage the content of objects 142 stored in DMS database 108 by storing an object 142 in DMS database 108, such as by creating a new object, importing an existing object, or checking in an edited version of an object. Additionally, a user may manage the content of objects 142 stored in DMS database 108 by creating security labels 144 corresponding to the objects 142 such that document management application 154 may determine those users 160 that are authorized to view links associated with the objects 142 based on a comparison of the security access profiles 148 of the users 160 and the security labels 144 corresponding to the objects 142, as described above.

In certain embodiments, managing the content of a document may also include the ability for the user 160 to create virtual containers and documents, displaying both the security access profile 148 of the user 130 and the security label 142 corresponding to the object 142 through multiple views, allowing the user 160 to examine versions of the object 142 for tracking security label components associated with the object 142 (maintaining the policies of no read up, no write down).

FIG. 3 illustrates example functions performed by users 160 and administrators 162 via IRM application 158 in an example system 100 for providing information rights management, according to certain embodiments of the present invention. System 100 includes a user 160 associated with a user system 102 and an administrator 162 associated with an administrative system 104. In the illustrated embodiment, IRM application 158 is operable to provide functionality associated with managing IRM policies (as indicated at reference numeral 170), managing IRM users (as indicated at reference numeral 172), and protecting the content of the objects 142 stored in DMS database 108 as well as objects 142 stored external to DMS database 108(as indicated at reference numeral 168).

In certain embodiments, an administrator 162 of administrative system 104 may manage IRM policies (as indicated at reference numeral 170) and manage IRM users (as indicated at reference numeral 172). Managing IRM policies may include defining one or more permission sets 150 stored in IRM database 112. The permission sets, when incorporated into an IRM wrapper 146 corresponding to an object 142, may define a number of actions (e.g., printing, copying, exporting) that a user accessing the object 142 may (or may not) perform. Managing IRM users may include creating new users, creating new groups, placing a user in a group, deleting users, or any other suitable function according to particular needs.

In certain embodiments, a user 160 of user system 102 may protect the content of the objects 142 in DMS database 108 as well as objects 142 stored external to DMS database 108 (as indicated at reference numeral 168). A user may protect the content of objects 142 stored either in DMS database 108 or external to DMS database 108 by generating IRM wrappers 146 corresponding to the objects 142 such that IRM application 158 may determine those users 160 that are authorized to access the objects 142 based on a comparison of the security access profiles 148 of the users 160 and the IRM profiles of the IRM wrappers 148 corresponding to the objects 142, as described above.

FIG. 4 illustrates an example IRM-protected object 142 stored in DMS database 108 in an example system 100 for providing information rights management, according to certain embodiments of the present invention. IRM-protected object 142 of DMS database 108 may have a corresponding security label 144 stored in DMS database 108. Security label 144 may include a clearance component, a secondary security component, and a handling component, as described above. One or more of the components of the security label 144 corresponding to the IRM-protected object 142 may be compared with the security access profile of a user by document management application 154 to determine whether a user is authorized to view a link associated with IRM-protected object 144, as described above. Although security label 144 is depicted and primarily described as including particular components, the present invention contemplates security label 144 including any other suitable components (e.g., date of creation of the corresponding object 142, location of creation of the corresponding object 142, or object number).

In certain embodiments, all or part of the security label 144 corresponding to the IRM-protected object 142 may be stored as part of an security label ACL 176 corresponding to the IRM-protected object 142. Furthermore, in determining whether a user is authorized to view links associated with the IRM-protected object 142, document management application 154 may compare security label ACL 176 with the security access profile of a requesting user (in addition to or in lieu of security label 144).

IRM-protected object 142 of DMS database 108 may also have a corresponding IRM wrapper 146 stored in DMS database 108. In embodiments in which multiple IRM servers 110 are present, IRM profile 178 may include a specification of a particular IRM server 110 responsible for determining whether a decryption key 152 associated with the corresponding IRM-protected object 142 should be communicated to a user requesting access to the IRM-protected object 142. Additionally, IRM profile 178 may include one or more IRM profile components. The one or more IRM profile components may be compared with the security access profile of a user requesting to access the IRM-protected object 142 by IRM application 158 in order to determine whether the requesting user is authorized to access the IRM-protected object 142, as described above. Although IRM wrapper 146 is depicted and primarily described as including particular components (i.e., IRM profile 178 and IRM permission sets 180), the present invention contemplates security label 144 including any other suitable components, according to particular needs.

In certain embodiments, all or part of IRM profile 178 and/or IRM permission sets 180 of IRM wrapper 146 corresponding to the IRM-protected object 142 may be stored as part of an IRM wrapper ACL 182 corresponding to the IRM-protected object 142. Furthermore, in determining whether a user is authorized to access the IRM-protected object 142, IRM application 158 may compare IRM wrapper ACL 182 with the security access profile of a requesting user (in addition to or in lieu of IRM profile 178). Additionally, having determined that a user is authorized to access the IRM-protected object 142, IRM application 158 may access security label ACL in order to apply the appropriate permission sets (in addition to or in lieu of permission sets 180).

FIG. 5 illustrates an example IRM-protected object 142 stored external to DMS database 108 in an example system 100 for providing information rights management, according to certain embodiments of the present invention. IRM-protected object 142 of external memory 132 may be an IRM-protected object 142 that has been exported from DMS database 108 by a user that is both authorized to access the IRM-protected object 142 (based on the components of the IRM profile 178 of the IRM wrapper corresponding to the object 142, as described above) and export the IRM-protected object 142 from DMS database 108 (based on the IRM permission sets 180 of the IRM wrapper 146 corresponding to the object 142, as described above).

IRM-protected object 142 of external memory 132 may have a corresponding IRM wrapper 146 stored in external memory 132. In other words, the IRM wrapper 146 corresponding to the IRM-protected object 142 stored in DMS database 108 (e.g., as illustrated in FIG. 4) may follow the IRM-protected object 142 when the IRM-protected object 142 is exported from DMS database 108 and stored external to DMS database 108 (e.g., in external memory 132 of user system 102). Because IRM-protected object 142 stored in external memory 132 corresponds to an IRM-protected object 142 exported from DMS database 108, the IRM wrapper 146 corresponding to the IRM-protected object 142 stored in external memory 132 may be substantially similar to the IRM wrapper 146 corresponding to the IRM protected document stored in DMS database 108 (as described above with regard to FIG. 4).

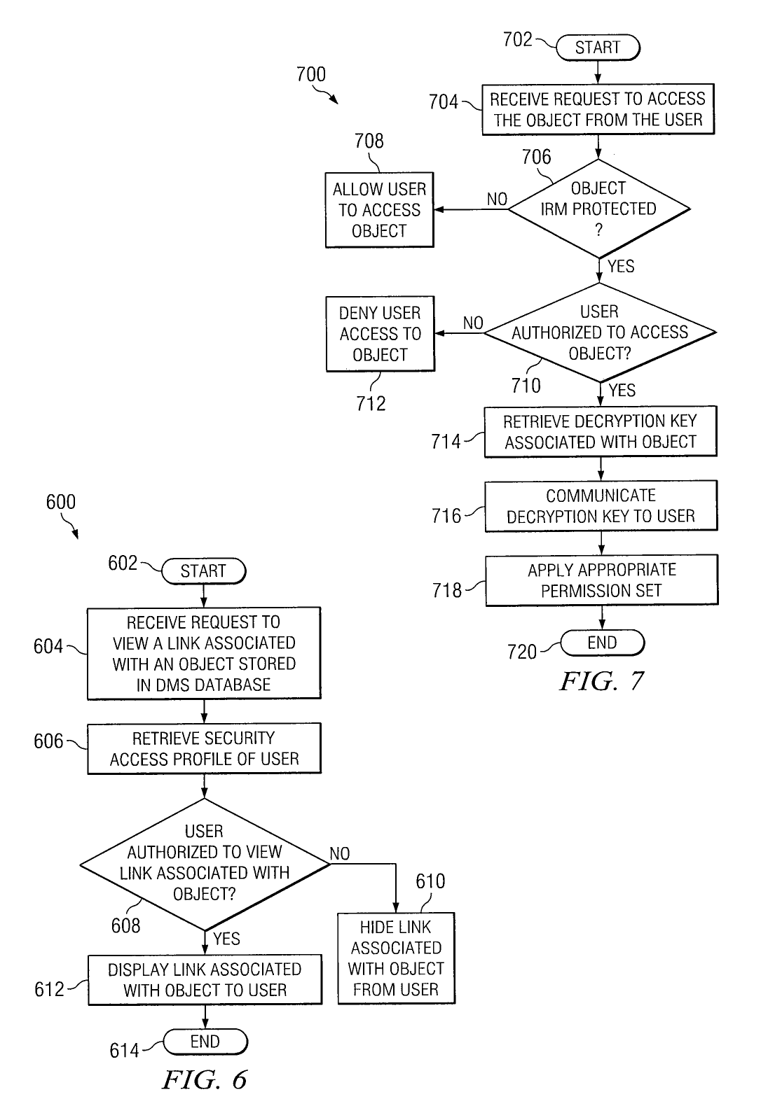

FIG. 6 illustrates an example method 600 for determining whether a user is authorized to view a link associated with an object 142 stored in DMS database 108 in an example system 100 for providing information rights management, according to certain embodiments of the present invention.

The method begins at step 602. At step 604, document management application 154 of DMS server 106 receives a request from a user of user system 102 to view a link associated with an object 142 stored in DMS database 108. The object 142 may have a corresponding security label 144 stored in DMS database 108. For example, a user may request to view a link associated with an object 142 stored in DMS database 108 by logging in (i.e., providing login credentials) to the document management system provided by the DMS server 106 coupled to the DMS database 108 (e.g., Documentum). As an addition example, a user may request to view a link associated with an object 142 stored in DMS database 108 by a submitting a query to DMS database 108.

In response to the receipt from a user of the request to view a link associated with an object 142 stored in DMS database 108, document management application 154 may retrieve the security access profile 148 of the user at step 606. Document management application 154 may determine, based on the retrieved security access profile 148, whether the user is authorized to view a link associated with the object 142 at step 608. In certain embodiments, document management application 154 may determine whether the user is authorized to view a link associated with the object 142 by comparing the accessed security access profile 148 of the user with the security label 144 corresponding to the object 142.

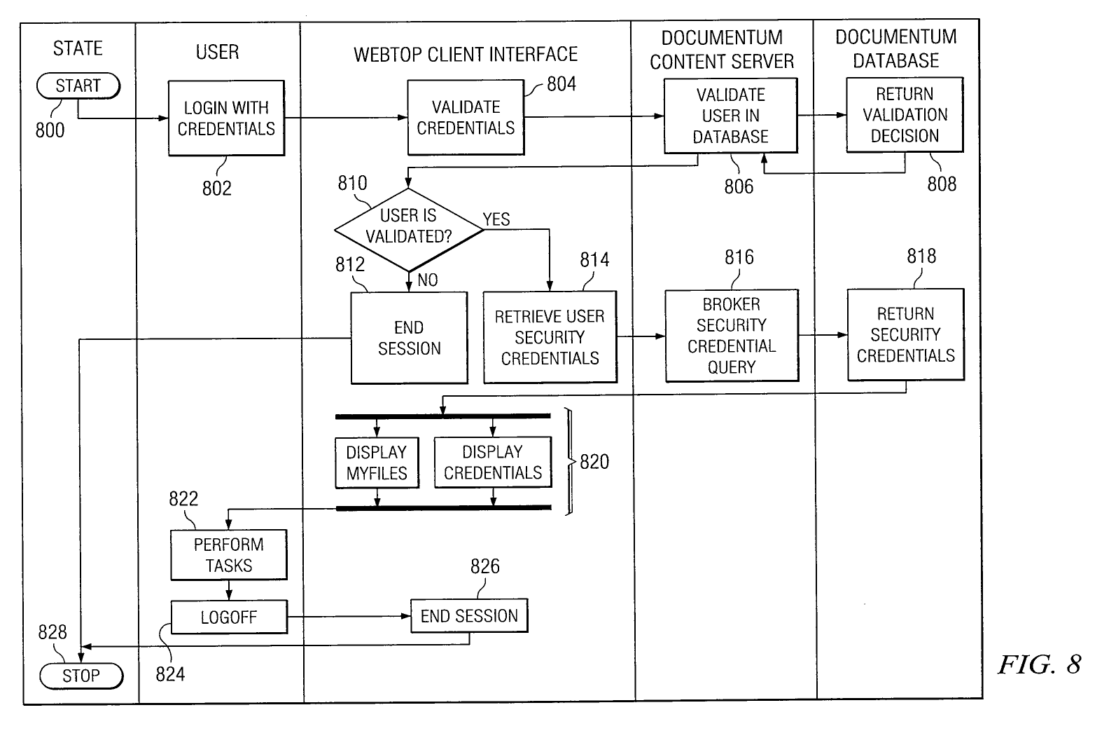

As a particular example, document management application 154 may determine whether a user is authorized to view a link associated with a particular object 142 stored in DMS database 108 in response to the receipt of user login credentials (e.g., username and password) from the user (described in further detail with regard to FIG. 8). The particular object 142 stored in DMS database 108 may have a corresponding security label 144 comprising a clearance component (SECRET) and a secondary security component (DALLAS OFFICE). Having validated the login credentials provided by a user, document management application 154 may compare at least a portion of the security access profile 148 of the validated user with at least a portion of the security label 144 corresponding to the particular object 142.

If the validated user has an associated security access profile 148 indicating that the user belongs to the TOP-SECRET clearance group and the DALLAS OFFICE secondary security group, document management application 154 may determine that the validated user is authorized to view a link associated with the particular object 142, as the validated user belongs to both groups specified by the components of the security label for the object 142. If, however, the validated user has an associated security access profile 148 indicating that the validated user belongs to the SECRET clearance group and the WASHINGTON OFFICE secondary security group, document management application 154 may determine that the validated user is not authorized to view a link associated with the object 142, as the secondary security group of the validated user (WASHINGTON OFFICE) is different than the secondary security component of the security label (DALLAS OFFICE).

If document management application 154 determines, based on the comparison of the security access profile 148 of the user and the security label 144 corresponding to the object 142, that the user is not authorized to view a link associate with the object 142, document management application 154 may hide the link associated with the object 142 at step 610 such that the user is not able to view the link. If document management application 154 determines that the user is authorized to view a link associate with the object 142, document management application 154 may display the link associated with the object 142 to the user at step 612. The method ends at step 614.

FIG. 7 illustrates an example method 700 for determining whether a user is authorized to access an object 142 stored either in DMS database 108 or external to DMS database 108 in an example system 100 for providing information rights management, according to certain embodiments of the present invention. The method begins at step 702. At step 704, a request to access an object 142 is received from a user.

The requested object 142 may be stored either in DMS database 108 or external to DMS database 108.

If the requested object is stored in DMS database 108, document management application 154 may receive the request to access the object 142 from the user (e.g., the user may request the object 142 stored in DMS database 108 by selecting a link associated with the object 142 displayed to the user, as described above). In response to the receipt of the request, document management system 154 may determine whether the requested object 142 is IRM protected at step 706.

If the requested object is stored external to DMS database 108 (e.g., in external memory 132 of user system 102), user application 128 of user system 102 may receive the request to access the object 142 (e.g., the user may attempt to open the object 142 using user application 128). In response to the receipt of the request, user application 128 may determine if the requested object is IRM protected at step 706.

If either document management application 154 or user application 128 determines that the requested object 142 is not IRM protected (i.e., the requested object does not have a corresponding IRM profile 146), the user may be allowed to access the requested object 142 at step 708. If either document management application 154 or user application 128 determines that the requested object 142 is IRM protected (i.e., the requested object has a corresponding IRM profile 146), the method proceeds to step 708.

At step 708, IRM application 158 of IRM server 110 determines whether the requesting user is authorized to access the requested object 142.

If the requested object 142 is stored in DMS database 108, client component 156 of DMS server 106 may invoke IRM client 130 of user system 102, and IRM client 130 may communicate with IRM application 158 of IRM server 130 such that IRM application 158 may determine whether the requesting user is authorized to access the requested object 142 at step 710.

If the requested object 142 is stored external to DMS database 108, user application 128 may invoke IRM client 130, and IRM client 130 may communicate with IRM application 158 of IRM server 130 such that IRM application 158 may determine whether the requesting user is authorized to access the requested object 142 at step 710.

At step 710, IRM application 158 may determine whether the requesting user is authorized to access the requested object 142 based on a comparison of the IRM profile of the IRM wrapper 146 corresponding to the requested object 142 with the security access profile 148 of the requesting user. Because the security access profile 148 may be stored in DMS database 108, IRM application 158 may communicate with document management application 154 of DMS server 106 in order to access the security access profile 148.

As a particular example, if the requested object 142 has a corresponding IRM wrapper 146 including an IRM profile having IRM profile components corresponding to a list of users (e.g., usernames and/or passwords of users) who are authorized to access the object 142, IRM application 158 may determine whether the accessed security access profile 148 of the requesting user contains information (e.g., a username and/or password) corresponding to an IRM profile component (e.g., a username and/or password of a user authorized to access the object 142) of the IRM wrapper 146 corresponding to the requested object 142.

If the accessed security access profile 148 of the requesting user does contain information corresponding to the IRM profile components of the IRM wrapper 146 corresponding to the requested object 142, IRM application 158 may determine that the user is authorized to access the requested object 142; otherwise, IRM application 158 may determine that the requesting user is not authorized to access the requested object 142.

As an additional particular example, if the requested object 142 has a corresponding IRM wrapper 146 including an IRM profile having IRM profile components corresponding to the one or more components of the security label 144 corresponding to the requested object 142 (e.g., a clearance component (SECRET) and a secondary security component (DALLAS OFFICE)), IRM application 158 may determine whether the security access profile 148 of the requesting user contains information (e.g., group memberships) corresponding to the IRM profile components (e.g., that the requesting user belongs to the SECRET clearance group and the DALLAS OFFICE secondary security group) of the IRM wrapper 146 corresponding to the requested object 142.

If the accessed security access profile 148 of the requesting user does contains information (e.g., group memberships) corresponding to the IRM profile components (e.g., a user name an password of a user authorized to access the object 142) of the IRM wrapper 146 corresponding to the requested object 142, IRM application 158 may determine that the requesting user is authorized to access the requested object 142; otherwise, IRM application 158 may determine that the requesting user is not authorized to access the requested object 142.

If IRM application 158 determines that the requesting user is not authorized to access the requested object 142, the requesting user is denied access to the requested object 142 at step 712. If IRM application 158 determines that the requesting user is authorized to access the requested object 142, the methods continues to step 714.

At step 714, IRM application 158 retrieves a decryption key 152 associated with the requested object 142 from IRM database 112. At step 716, IRM application 158 communicates the decryption key 152 associated with the requested object 142 to the requesting user such that the requesting user may open the requested object using user application 128 by decrypting the encrypted data of the object 142.

At step 718, IRM client 130 applies the permission set of the IRM wrapper 146 corresponding to the requested object 142 (or the appropriate permission set in embodiments in which the IRM wrapper 146 includes differing permission sets for differing user or groups of users). IRM client 130 may apply the permission set of the IRM wrapper 146 corresponding to the requested object 142 by disabling the those functions that a user is not authorized to perform in user application 128. The method ends at step 720.

FIG. 8 illustrates an example method for determining whether a user is authorized to view links associated with objects 142 stored in DMS database 108 in response to the receipt of login credentials from the user, according to certain embodiments of the present invention. In the method described below, it is understood that actions described below as being performed by the administrator may be performed by the administrator using an administrative system (such as administrative system 104 of system 100) and actions described below as being performed by the user may be performed by the user of a user system (such as user system 102 of system 100).

The method begins at step 800. At step 802, user 160 provides login credentials. In certain embodiments, the login credentials include a username and password; however, the present invention contemplates the use of any suitable login credentials. At step 804, the client interface provided by client component 156 validates the credentials provided by user 160 and communicates the credentials to document management application 154. At step 806, the document management application 154 validates that the set of credentials provided by user 160 correspond to a set of credentials stored in a security access profile 148 in the DMS database 108. At step 808, the DMS database 108 returns a validation decision for the user.

At step 810, the client interface provided by client component 156 processes the received validation decision. If user 130 was not validated, at step 812 the client interface provided by client component 156 may end the session for the user 130. If user 130 was validated, the client component 156 may retrieve the security access profile 148 for the user 160. For example, the document management application 156 may query the DMS database 108 at step 816, and the DMS database 108 may return the security access profile 148 at step 818. Based on the returned security access profile 148 for user 160, at step 820 the client interface provided by client component 156 provides a display to user 160 of the group memberships of user 160 and links associated with objects 142 belonging to user 160.

Additionally, the client interface provided by client component 156 may provide a display of links to objects 142 stored in DMS database 108 that the user 160 is authorized to view, the links the user 160 is authorized to view being determined by document management application 154 based on a comparison of the security labels 144 corresponding to objects 142 stored in DMS database 108 and the security access profile 148 of the user 160 (as described above).

At step 822, user 160 may perform any of a number of tasks. At step 824, user 130 logs off document management application 154, and at step 826 the session ends.

Although the present invention has been described with several embodiments, diverse changes, substitutions, variations, alterations, and modifications may be suggested to one skilled in the art, and it is intended that the invention encompass all such changes, substitutions, variations, alterations, and modifications as fall within the spirit and scope of the appended claims.

What is claimed is:

1. A method for providing information rights management, comprising:
receiving, from a user having an associated security access profile, a request to access an object, the object having:
a corresponding information rights management (IRM) wrapper stored with the object both when the object is stored in a document management system (DMS) database and when the document is stored external to the DMS database, the IRM wrapper comprising:
an IRM profile; and
one or more IRM permission sets; and
encrypted data;
determining whether the user is authorized to access the object based on a comparison of the security access profile of the user and the IRM profile of the IRM wrapper corresponding to the object; and
communicating to the user, in response to a determination that the user is authorized to access the object, a decryption key associated with object.

2. The method of claim 1, wherein:
the security access profile associated with the user comprises a username associated with the user;
the IRM profile of the IRM wrapper corresponding to the object comprises one or more usernames of users that are authorized to access the object; and
determining whether the user is authorized to access the object based on a comparison of the security access profile of the user and the IRM profile of the IRM wrapper corresponding to the object comprises determining whether the username associated with the user of the security access profile is one of the one or more usernames of the IRM profile.

3. The method of claim 1, wherein:
the security access profile associated with the user comprises one or more group memberships associated with the user;
the IRM profile of the IRM wrapper corresponding to the object comprises one or more groups of users that are authorized to access the object; and
determining whether the user is authorized to access the object based on a comparison of the security access profile of the user and the IRM profile of the IRM wrapper corresponding to the object comprises determining whether the one or more group memberships associated with the user of the security access profile correspond to the one of the one or more groups of users that are authorized to access the object of the IRM profile.

4. The method of claim 1, comprising decrypting the encrypted data of the object using the decryption key.

5. The method of claim 1, wherein:
the object is stored in a DMS database storing a plurality of objects;
the object has a corresponding security label.

6. The method of claim 5, comprising:
receiving a request to view links corresponding to the plurality of objects stored in the DMS database;
determining whether the user is authorized to view a link corresponding to the object based on a comparison of the security access profile of the user and the security label corresponding to the object; and
displaying to the user, in response to a determination that the user is authorized to view the link corresponding to the object, the link corresponding to the object such that the user may, by selecting the link corresponding to the object, request to access the object.

7. The method of claim 5, wherein:
the security label corresponding to the object is stored in the DMS database; and
the IRM wrapper corresponding to the object is stored in the DMS database.

8. The method of claim 7, comprising allowing the user, in response to the determination that the user is authorized to access the object, to export the object and the IRM wrapper corresponding to the object from the DMS database such that the object and the IRM wrapper corresponding to the object may be stored in a memory unit external to the DMS database.

9. The method of claim 1, wherein the object is stored in a memory unit external to the DMS database.

10. The method of claim 9, wherein the IRM wrapper corresponding to the object is stored in the memory unit external to the DMS database.

11. The method of claim 1, comprising:
receiving a request to perform a particular action with respect to the object; and
determining, based on a comparison of the requested particular action with a corresponding permission of the one or more permission sets of the IRM wrapper corresponding to the object, whether the user is authorized to perform the particular action with respect to the object.

12. A system for providing information rights management, comprising:
one or more processing units operable to:
receive, from a user having an associated security access profile, a request to access an object, the object having:
a corresponding information rights management (IRM) wrapper stored with the object both when the object is stored in a document management system (DMS) database and when the document is stored external to the DMS database, the IRM wrapper comprising:
an IRM profile; and
one or more IRM permission sets; and
encrypted data;
determine whether the user is authorized to access the object based on a comparison of the security access profile of the user and the IRM profile of the IRM wrapper corresponding to the object; and
communicate to the user, in response to a determination that the user is authorized to access the object, a decryption key associated with object.

13. The system of claim 12, comprising a DMS database storing a plurality of objects, wherein:
the object is stored in the DMS database; and
the object has a corresponding security label.

14. The method of claim 13, wherein the one or more processing units are operable to:
receive a request to view links corresponding to the plurality of objects stored in the DMS database;
determine whether the user is authorized to view a link corresponding to the object based on a comparison of the security access profile of the user and the security label corresponding to the object; and
display to the user, in response to a determination that the user is authorized to view the link corresponding to the object, the link corresponding to the object such that the user may, by selecting the link corresponding to the object, request to access the object.

15. The system of claim 13, wherein:
the security label corresponding to the object is stored in the DMS database; and
the IRM wrapper corresponding to the object is stored in the DMS database.

16. The system of claim 15, wherein the one or more processing units are operable to allow the user, in response to the determination that the user is authorized to access the object, to export the object and the IRM wrapper corresponding to the object from the DMS database such that the object and the IRM wrapper corresponding to the object may be stored in a memory unit external to the DMS database.

17. The system of claim 12, comprising a memory unit external to the DMS database, wherein the object is stored in the memory unit external to the DMS database.

18. The system of claim 17, wherein the IRM wrapper corresponding to the object is stored in the memory unit external to the DMS database.

19. The system of claim 12, wherein the one or more processing units are operable to:
receive a request to perform a particular action with respect to the object; and
determine, based on a comparison of the requested particular action with a corresponding permission of the one or more permission sets of the IRM wrapper corresponding to the object, whether the user is authorized to perform the particular action with respect to the object.

20. Software for providing information rights management, the software embodied in a computer-readable medium and operable when executed to perform operations comprising:
receiving, from a user having an associated security access profile, a request to access an object, the object having:
a corresponding information rights management (IRM) wrapper stored with the object both when the object is stored in a document management system (DMS) database and when the document is stored external to the DMS database, the IRM wrapper comprising:
an IRM profile; and
one or more IRM permission sets; and
encrypted data;
determining whether the user is authorized to access the object based on a comparison of the security access profile of the user and the IRM profile of the IRM wrapper corresponding to the object; and
communicating to the user, in response to a determination that the user is authorized to access the object, a decryption key associated with object.
